(19) United States
(12) Patent Application Publication
(10) Pub. No.: US 2014/0212046 A1
(43) Pub. Date: Jul. 31, 2014

(54) BIT DEPTH REDUCTION TECHNIQUES FOR LOW COMPLEXITY IMAGE PATCH MATCHING

(71) Applicant: SONY CORPORATION, Tokyo (JP)

(72) Inventors: Tak Shing Wong, Fremont, CA (US); Alexander Berestov, San Jose, CA (US); Xiaogang Dong, Germantown, MD (US)

(73) Assignee: SONY CORPORATION, Tokyo (JP)

(21) Appl. No.: 13/755,393

(22) Filed: Jan. 31, 2013

(51) Int. Cl. G06T 7/00

(52) U.S. Cl. CPC G06T 7/00
USPC 382/194

(57) ABSTRACT

Two different approaches for reducing the bit depth of the image data so as to reduce the computation and hardware requirement of image patch matching, with minimal loss of matching accuracy are described. Patch matching is able to be implemented in many different ways, but generally involves matching one area of an image with another area of the same image or another area of a different image (e.g. another video frame) through the use of a matching cost function. Transforming the image data to lower bit depth, image processing techniques are able to be implemented to minimize the needed memory and other resources for patch-matching. The complexity/performance trade-off of the approaches are also adjustable so that they are able to be applied for applications with different quality requirements and hardware constraints.

### FIELD OF THE INVENTION

The present invention relates to the field of image processing. More specifically, the present invention relates to image patch matching.

### BACKGROUND OF THE INVENTION

Image patch matching is a fundamental operation that is important in several applications, for example, still image denoising, motion estimation in video coding and stereo vision correspondence matching. Recent methods of image denoising are described in Antoni Buades, Bartomeu Coll, and Jean-Michel Morel, “A Non-Local Algorithm for Image Denoising,” in Proceedings of the 2005 IEEE Computer Society Conference on Computer Vision and Pattern Recognition (CVPR'05), Vol. 2, pp. 60-65, Washington, DC, USA and K. Dabov, A. Foi, V. Katkovnik, and K. Egiazarian, “Image denoising by sparse 3D transform-domain collaborative filtering,” IEEE Trans. Image Process., vol. 16, no. 8, pp. 2080-2095, August 2007. The use of patch matching for motion estimation used in video codec standards MPEG-1, MPEG-2, MPEG-4 is further described in K. R. Rao and J. J Hwang, Techniques and Standards for Image, Video and Audio Coding. Englewood Cliffs, N.J.: Prentice Hall, 1996. Stereo vision correspondence matching is further described in Kuk-Jin Yoon and In So Kweon, “Adaptive Support-Weight Approach for Correspondence Search,” IEEE Trans. Pattern Anal. Mach. Intell. Vol. 28, No. 4, April 2006.

Given an image patch, the target patch, the objective of patch matching is to find, from within the same image or from different video frames, those other image patches that are similar to the target patch based on a similarity criterion or cost function. Due to the large amount of data that needs to be processed typically, applying patch matching for real-time applications is usually difficult without the use of expensive, dedicated hardware.

### SUMMARY OF THE INVENTION

Two different approaches for reducing the bit depth of the image data so as to reduce the computation and hardware requirement of image patch matching, with minimal loss of matching accuracy are described. Patch matching is able to be implemented in many different ways, but generally involves matching one area of an image with another area of the same image or another area of a different image (e.g. another video frame) through the use of a matching cost function. Transforming the image data to lower bit depth, image processing techniques are able to be implemented to minimize the needed memory and other resources for patch-matching. The complexity/performance trade-off of the approaches are also adjustable so that they are able to be applied for applications with different quality requirements and hardware constraints.

In one aspect, a method of bit-depth reduction programmed in a memory of a device comprises selecting a number of n bits for each pixel, computing a local mean for each pixel by averaging pixel values within a local window of an image around a current pixel, determining a leading bit position using the local mean and selecting the n bits for the current pixel, wherein the n bits are the one starting from and following the leading bit position. The n bits is fewer than a total bit depth. The local mean is computed utilizing pixel intensity. Patch matching utilizes a transformed, reduced bit-depth image of the original image. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, an apparatus comprises an image acquisition component for acquiring an image, a memory for storing an application, the application for generating a transformed, reduced bit-depth image of the image, computing a local mean for each pixel by averaging pixel values within a local window around a current pixel, determining a leading bit position using the local mean and selecting the n bits for the current pixel, wherein the n bits are the ones starting from and following the leading bit position and a processing component coupled to the memory, the processing component configured for processing the application. The chosen n bits is fewer than a total bit depth. The local mean is computed utilizing pixel intensity.

In another aspect, a method of bit-depth reduction programmed in a memory of a device comprises selecting a search window for each target patch, computing a local mean using a local window around the target patch, determining a leading bit from the local mean for each target patch and transforming the search window into a low bit-depth window by choosing n bits from each pixel in the search window, wherein the n bits are the ones starting from and following the leading bit position. The search window comprises a list of candidate patches. The reduced bit-length is less than a total bit depth. The local mean is computed utilizing pixel intensity. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

In another aspect, an apparatus comprises an image acquisition component for acquiring an image, a memory for storing an application, the application for selecting a search window from the image for each target patch, computing a local mean by averaging pixel values within a local window around the target patch, determining a leading bit position using the local mean and transforming the search window into a low bit-depth window by choosing n bits from each pixel in the search window, wherein the n bits are the ones starting from and following the leading bit position and a processing component coupled to the memory, the processing component configured for processing the application. The search window comprises a list of candidate patches. The chosen n bits is fewer than a total bit depth. The local mean is computed utilizing pixel intensity.

### BRIEF DESCRIPTION OF THE DRAWINGS

FIG. 1 illustrates an exemplary application according to some embodiments.

FIG. 2 illustrates mean-guided dynamic range compression according to some embodiments.

FIG. 3 illustrates how to determine the leading bit according to some embodiments.

FIG. 4 illustrates quantization levels according to some embodiments.

FIGS. 5A-B illustrate exemplary transformed images according to some embodiments.

FIG. 6 illustrates a block diagram of a variation of mean-guided dynamic range compression according to some embodiments.

FIG. 7 illustrates performance results according to some embodiments.

FIG. 8 illustrates a block diagram of an exemplary computing device configured to implement the bit-depth reduction method according to some embodiments.

### DETAILED DESCRIPTION OF THE PREFERRED EMBODIMENT

Two different approaches for reducing the bit depth of the image data so as to reduce the computation and hardware requirement of image patch matching, with minimal loss of matching accuracy are described. The complexity/performance trade-off of the approaches are also adjustable so that they are able to be applied for applications with different quality requirements and hardware constraints.

Patch matching is an important operation used in many different applications, for example, still image denoising, motion estimation in video coding and stereo vision correspondence matching. The objective is to find other image patches that are similar to any given target patch from within the same image or from other video frames. Patch matching determines which candidate patch or patches are most similar to a target patch. A matching cost function is able to be used to define the similarity or dissimilarity of the patches. Examples of matching cost functions are Sum of Absolute Difference (SAD), Sum of Squared Difference (SSD), Weighted Sum of Absolute Difference (WSAD) and Weighted Sum of Squared Difference (WSSD). The computation complexity depends on the size of the patch, the number of candidate patches and the number of bits in each pixel (also referred to as bit depth). For example, for a monochrome (grayscale) image, if a bit depth for pixels is 1, the pixel is either black or white, but a bit depth of 12 results to 2¹² or 4096 different levels of gray pixels. When the bit-depth is 12 bits, the computational requirements are significant.

The operation is computationally expensive and hardware demanding due to the large amount of data that is processed typically. Two schemes to reduce the bit depth of the image data are described which reduce the computation complexity of patch matching, reduce the dedicated hardware cost and allow the operation to be applicable to a wider range of applications and products. The schemes described herein include flexibility in adjusting the complexity/matching accuracy tradeoff.

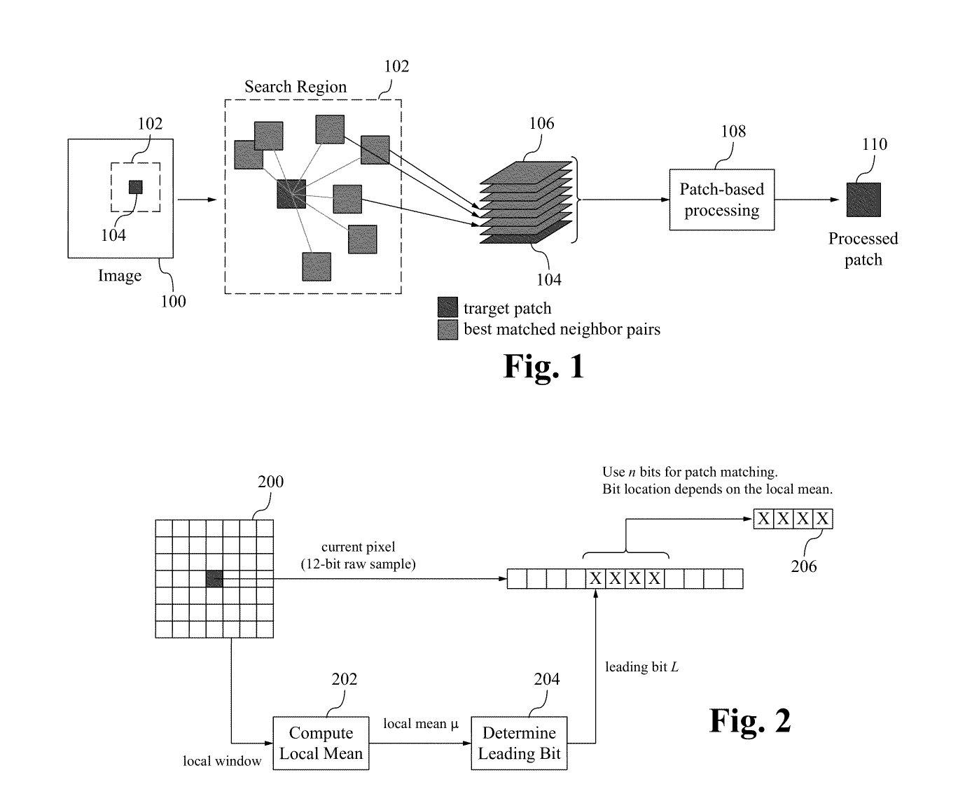

FIG. 1 illustrates an exemplary image processing application using patch matching according to some embodiments. The scheme takes an image 100 and defines a search region or window 102 around each target patch 104. Each T×T patch (or another patch size) is processed by searching for one or more best matching patches 106 from a K×K window 102. The patch-based processing module 108 then exploits the information redundancy in the matched patches to perform its designated functions, which may be, for example, motion estimation, image denoising, stereo vision correspondence matching, or some other tasks, to generate a processed patch 110. The complexity of patch matching is directly proportional to the bit depth of the data. For example, reducing the bit depth from 12 bits per pixel to 4 bits per pixel is able to reduce search complexity by 67%. Thus, the objective is to capture as much image information as possible in the reduced bit-depth data to maximize the matching accuracy.

FIG. 2 illustrates mean-guided dynamic range compression (MG-DRC) according to some embodiments. A whole L-bit image is converted to a reduced bit-depth, n-bit image where n<L. The value n is able to be selected (e.g., 3 or 4). Only n bits from each pixel of the image 200 are used for patch matching. For each pixel, a local mean 202 is used to determine which bits to use. The local mean 202 provides the order of sample magnitudes in the neighborhood. There are many methods to compute the local mean. For example, one method is to compute the local mean by simple averaging with an R×R local window defined as

$$μ ( s ) = \frac{1}{\vert {W}_{s} \vert} {\sum }_{i ∈ {W}_{A}} x ( t ) ,$$

where s is the current pixel, Wₛ is the R×R averaging window, ¦Wₛ¦ is the number of pixels in the window and x(t) is the intensity of pixel t. After computing the local mean, a leading bit position, L 204, described in more detail in the next paragraph, will be computed from the local mean. The n bits selected from the current pixel will be those n bits starting from and following the leading bit position 204.

FIG. 3 illustrates how to determine the leading bit according to some embodiments. If the local mean is μ, L=round[log₂γμ], where γ is a parameter of the algorithm. L takes values 0, 1, . . . , or B-1, where B is the bit depth of the original image and where L=0 corresponds to the Least Significant Bit (LSB), or the right-most bit. In an example, L=4 corresponds to the range of local mean 2^{3.5}≦μ≦2^{4.5}, for γ=1. In selecting the n-bits from the current pixel, if the pixel value is too large (≧2^{L+1}), the value is clipped to an n-bit sequence of 1's.

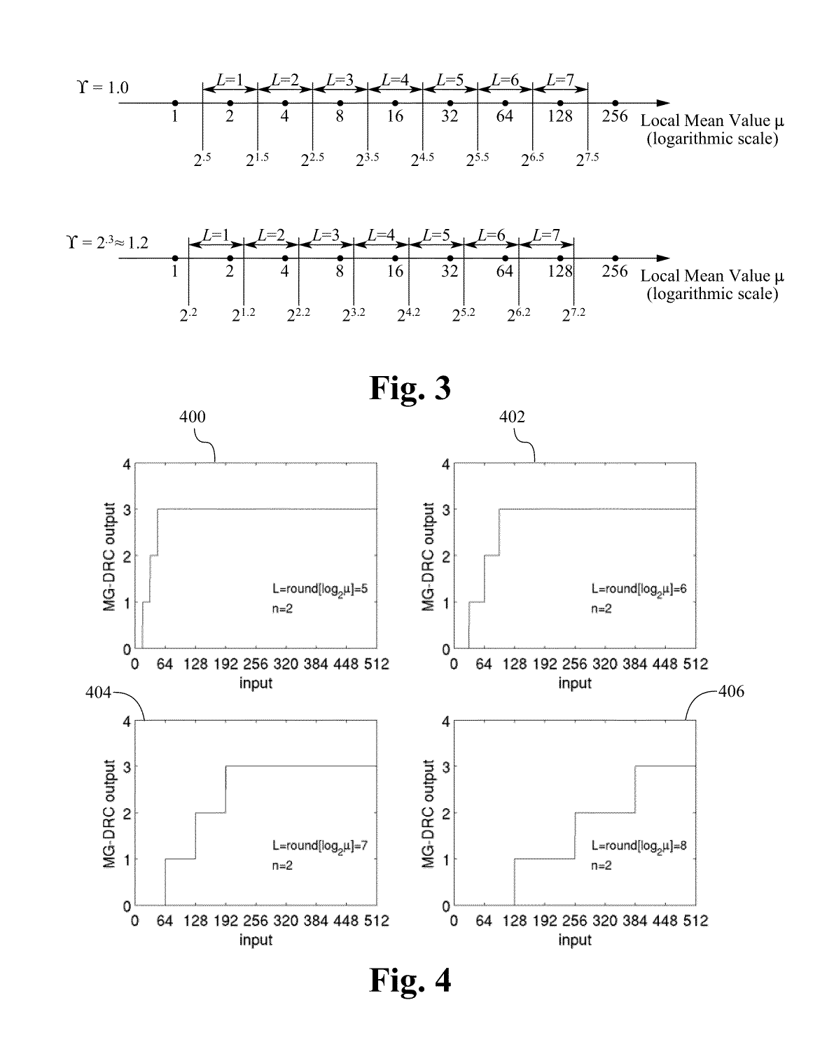

FIG. 4 illustrates quantization levels according to some embodiments. Graph 400 illustrates mean-guided dynamic range compression output with an L value of 5. Graph 402 illustrates mean-guided dynamic range compression output with an L value of 6. Graph 404 illustrates mean-guided dynamic range compression output with an L value of 7. Graph 406 illustrates mean-guided dynamic range compression output with an L value of 8.

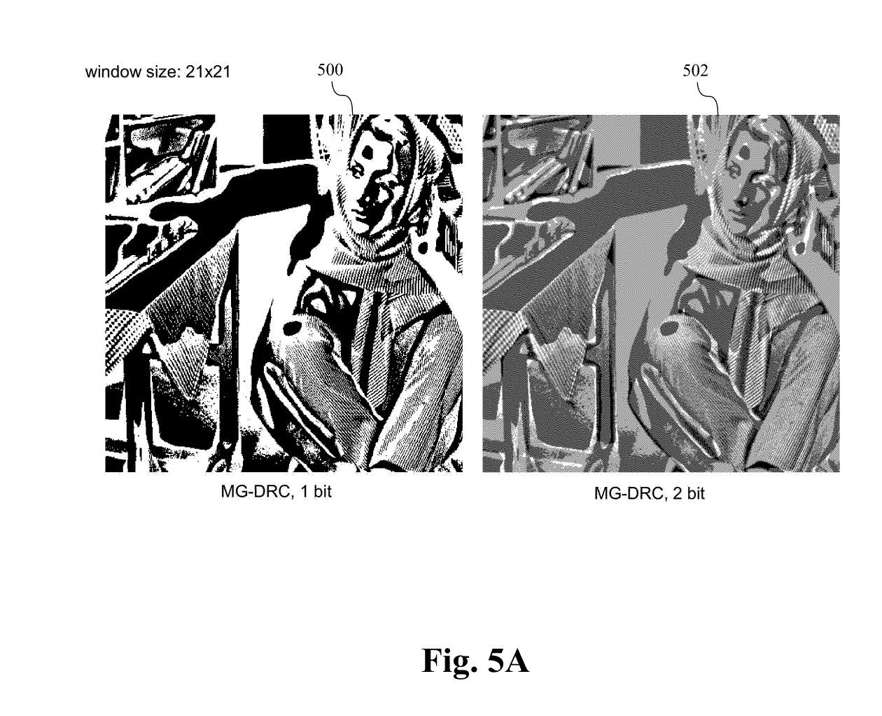

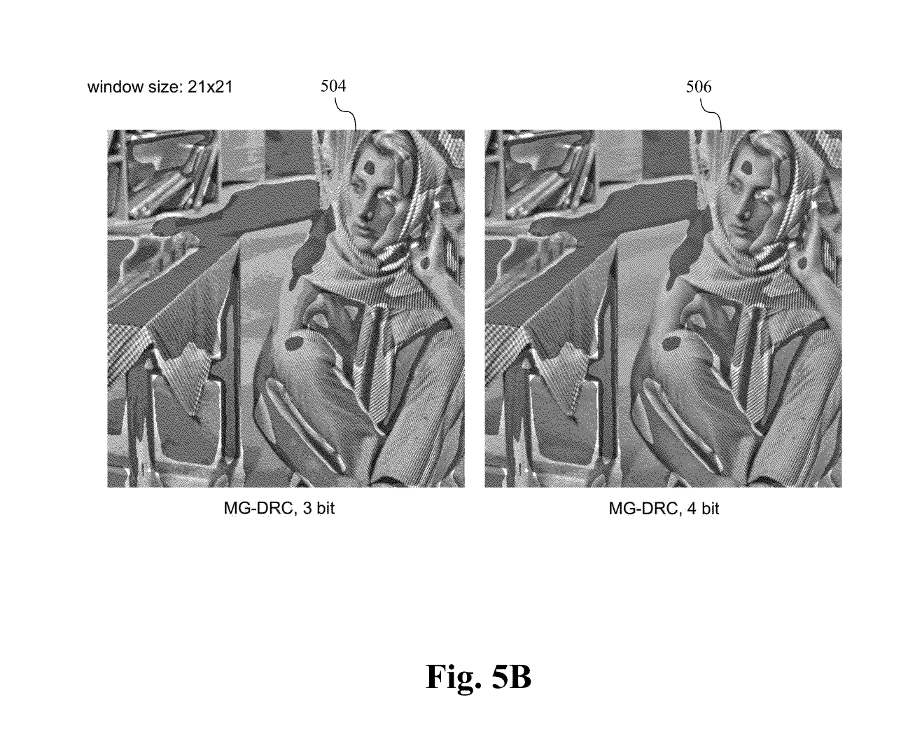

FIGS. 5A-B illustrate exemplary transformed images according to some embodiments. Image 500 is an image transformed using 1-bit mean-guided dynamic range compression. Image 502 is an image transformed using 2-bit mean-guided dynamic range compression. Image 504 is an image transformed using 3-bit mean-guided dynamic range compression. Image 506 is an image transformed using 4-bit mean-guided dynamic range compression.

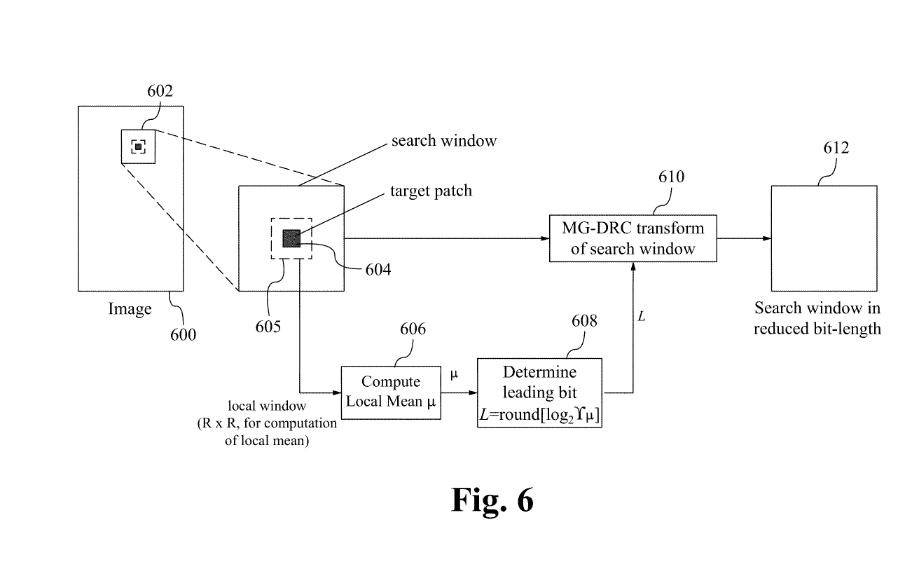

FIG. 6 illustrates a block diagram of a variation of mean-guided dynamic range compression according to some embodiments. Mean-guided dynamic range compression with local quantization (MG-DRC-LQ) is a variation of mean-guided dynamic range compression (MG-DRC) which performs local quantization only to the search window instead of to the whole image to improve image processing performance. For each target patch 604, an R×R local window 605 of an image 600 around the target patch is used to compute the local mean μ 606. The leading bit position L 608 is determined from the local mean by L=round[log₂γμ]. The same leading bit L is used to transform 610 all of the pixels in the search window. Because the same L is used to transform all pixels, MG-DRC-LQ is able to preserve the intensity ordering in the reduced bit-depth search window 612. This means that for any two pixels s and t, if x(s)<x(t) in the original image, the ordering of their intensities in the quantized search window will be the same, e.g., x′(s)<x′(t). MG-DRC-LQ does not generate a single transformed image. A pixel is transformed to different values depending on which search window being used.

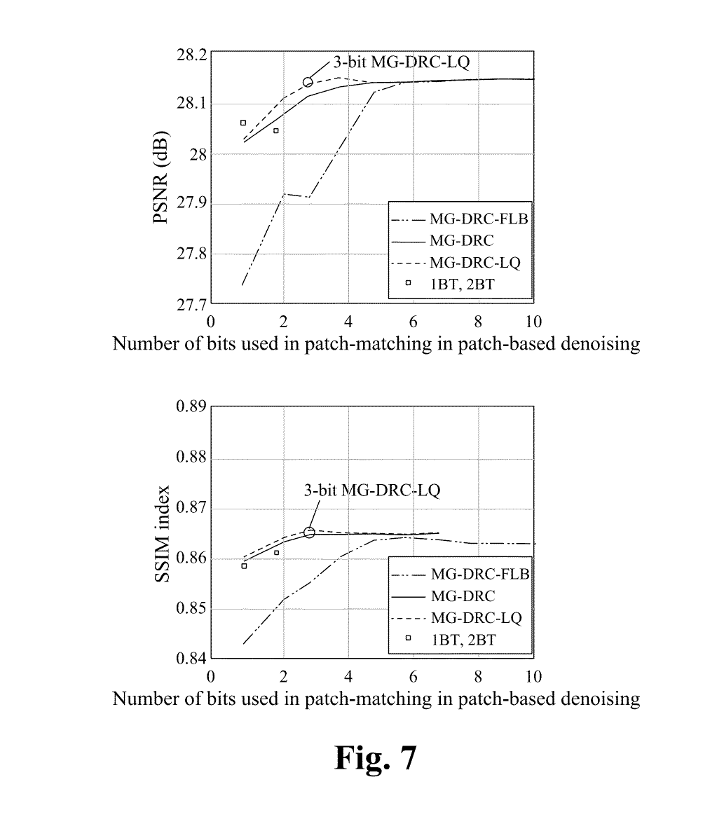

FIG. 7 illustrates the performance of a patch-based image denoising scheme according to some embodiments. The 3-bit mean-guided dynamic range compression with local quantization (MG-DRC-LQ) leads to similar denoising performance (in PSNR and SSIM) as that of using 4-bit mean-guided dynamic range compression (MG-DRC) and 12-bit full search. MG-DRC-FLB, also shown in the comparison, is MG-DRC where the leading bit position L is fixed to the most significant bit of the data. A one-bit transform (1BT) and a two-bit (2BT) transform are also shown which are described further in B. Natarajan, V. Bhaskaran, and K. Konstantinides, “Low-Complexity Block-Based Motion Estimation via One-Bit Transforms,” IEEE Trans. On Circuits and Systems for Video Tech., vol. 7, No. 4, August 1997 and A. Ertürk and S. Ertürk, “Two-Bit Transform for Binary Block Motion Estimation,” IEEE Transactions on Circuits and Systems for Video Technology, vol. 15, no. 7, July 2005, respectively.

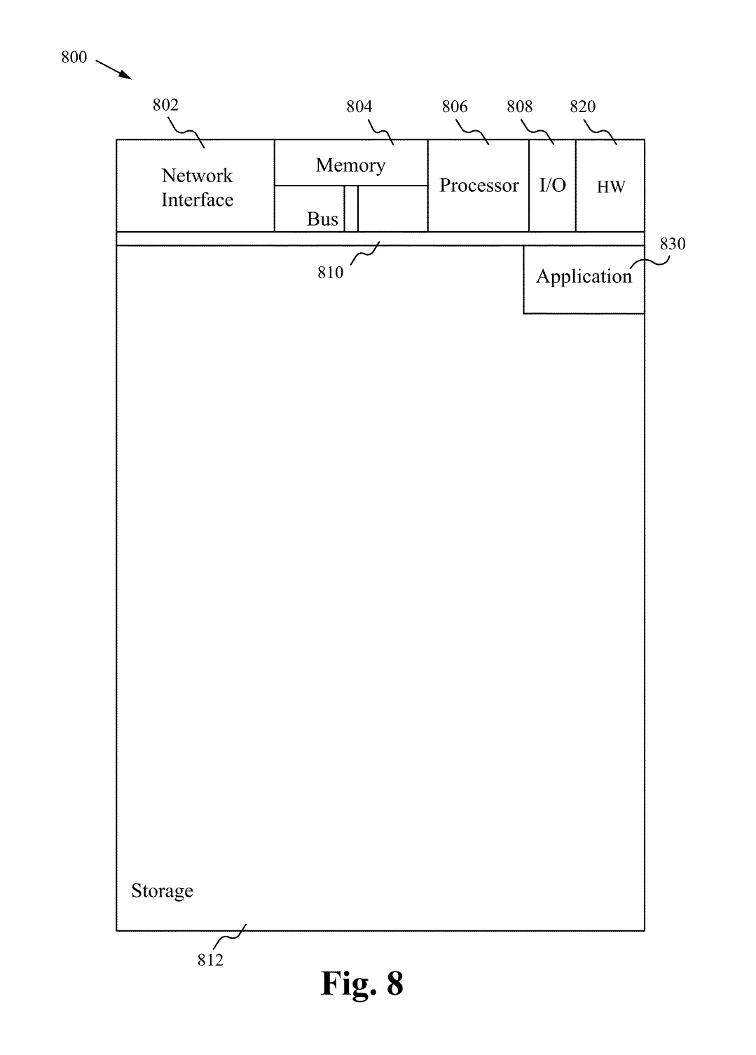

FIG. 8 illustrates a block diagram of an exemplary computing device configured to implement the bit-depth reduction method according to some embodiments. The computing device 800 is able to be used to acquire, store, compute, process, communicate and/or display information such as images and videos. In general, a hardware structure suitable for implementing the computing device 800 includes a network interface 802, a memory 804, a processor 806, I/O device(s) 808, a bus 810 and a storage device 812. The choice of processor is not critical as long as a suitable processor with sufficient speed is chosen. The memory 804 is able to be any conventional computer memory known in the art. The storage device 812 is able to include a hard drive, CDROM, CDRW, DVD, DVDRW, flash memory card or any other storage device. The computing device 800 is able to include one or more network interfaces 802. An example of a network interface includes a network card connected to an Ethernet or other type of LAN. The I/O device(s) 808 are able to include one or more of the following: keyboard, mouse, monitor, display, printer, modem, touchscreen, button interface and other devices. Bit-depth reduction application(s) 830 used to perform the bit-depth reduction method are likely to be stored in the storage device 812 and memory 804 and processed as applications are typically processed. More or fewer components shown in FIG. 8 are able to be included in the computing device 800. In some embodiments, bit-depth reduction hardware 820 is included. Although the computing device 800 in FIG. 8 includes applications 830 and hardware 820 for the bit-depth reduction method, the bit-depth reduction method is able to be implemented on a computing device in hardware, firmware, software or any combination thereof. For example, in some embodiments, the bit-depth reduction applications 830 are programmed in a memory and executed using a processor. In another example, in some embodiments, the bit-depth reduction hardware 820 is programmed hardware logic including gates specifically designed to implement the bit-depth reduction method.

In some embodiments, the bit-depth reduction application(s) 830 include several applications and/or modules. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player (e.g., DVD writer/player, Blu-ray® writer/player), a television, a home entertainment system or any other suitable computing device.

To utilize the bit-depth reduction method, a user acquires a video/image such as on a digital camcorder, and while or after the content is acquired, the bit-depth reduction method automatically transforms the data to lower bit-depth and performs patch matching for further processing such as denoising and motion estimation. The bit-depth reduction method occurs automatically without user involvement.

In operation, the bit-depth reduction method reduces the computation complexity of patch matching, and reduces the dedicated hardware cost. The transformed bit-depth n can be adjusted for different complexity/performance trade-off so that the method is applicable to a wide range of applications and products.

### SOME EMBODIMENTS OF BIT DEPTH REDUCTION TECHNIQUES FOR LOW COMPLEXITY IMAGE PATCH MATCHING

1. A method of bit-depth reduction programmed in a memory of a device comprising:
   a. selecting a number of n bits for each pixel;
   b. computing a local mean for each pixel by averaging pixel values within a local window of an image around a current pixel;
   c. determining a leading bit position using the local mean; and
   d. selecting the n bits for the current pixel, wherein the n bits are the one starting from and following the leading bit position.
2. The method of clause 1 wherein the n bits is fewer than a total bit depth.
3. The method of clause 1 wherein the local mean is computed utilizing pixel intensity.
4. The method of clause 1 wherein patch matching utilizes a transformed, reduced bit-depth image of the original image.
5. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
6. An apparatus comprising:
   a. an image acquisition component for acquiring an image;
   b. a memory for storing an application, the application for:
      i. generating a transformed, reduced bit-depth image of the image;
      ii. computing a local mean for each pixel by averaging pixel values within a local window around a current pixel;
      iii. determining a leading bit position using the local mean; and
      iv. selecting the n bits for the current pixel, wherein the n bits are the ones starting from and following the leading bit position; and
   c. a processing component coupled to the memory, the processing component configured for processing the application.
7. The apparatus of clause 6 wherein the chosen n bits is fewer than a total bit depth.
8. The apparatus of clause 6 wherein the local mean is computed utilizing pixel intensity.
9. A method of bit-depth reduction programmed in a memory of a device comprising:
   a. selecting a search window for each target patch;
   b. computing a local mean using a local window around the target patch;
   c. determining a leading bit from the local mean for each target patch; and
   d. transforming the search window into a low bit-depth window by choosing n bits from each pixel in the search window, wherein the n bits are the ones starting from and following the leading bit position.
10. The method of clause 9 wherein the search window comprises a list of candidate patches.
11. The method of clause 9 wherein the reduced bit-length is less than a total bit depth.
12. The method of clause 9 wherein the local mean is computed utilizing pixel intensity.
13. The method of clause 9 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.
14. An apparatus comprising:
   a. an image acquisition component for acquiring an image;
   b. a memory for storing an application, the application for:
      i. selecting a search window from the image for each target patch;
      ii. computing a local mean by averaging pixel values within a local window around the target patch;
      iii. determining a leading bit position using the local mean; and
      iv. transforming the search window into a low bit-depth window by choosing n bits from each pixel in the search window, wherein the n bits are the ones starting from and following the leading bit position; and
   c. a processing component coupled to the memory, the processing component configured for processing the application.
15. The apparatus of clause 14 wherein the search window comprises a list of candidate patches.
16. The apparatus of clause 14 wherein the chosen n bits is fewer than a total bit depth.
17. The apparatus of clause 14 wherein the local mean is computed utilizing pixel intensity.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of bit-depth reduction programmed in a memory of a device comprising:
a. selecting a number of n bits for each pixel;
b. computing a local mean for each pixel by averaging pixel values within a local window of an image around a current pixel;
c. determining a leading bit position using the local mean; and
d. selecting the n bits for the current pixel, wherein the n bits are the one starting from and following the leading bit position.

2. The method of claim 1 wherein the n bits is fewer than a total bit depth.

3. The method of claim 1 wherein the local mean is computed utilizing pixel intensity.

4. The method of claim 1 wherein patch matching utilizes a transformed, reduced bit-depth image of the original image.

5. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

6. An apparatus comprising:
a. an image acquisition component for acquiring an image;
b. a memory for storing an application, the application for:
i. generating a transformed, reduced bit-depth image of the image;
ii. computing a local mean for each pixel by averaging pixel values within a local window around a current pixel;
iii. determining a leading bit position using the local mean; and
iv. selecting the n bits for the current pixel, wherein the n bits are the ones starting from and following the leading bit position; and
c. a processing component coupled to the memory, the processing component configured for processing the application.

7. The apparatus of claim 6 wherein the chosen n bits is fewer than a total bit depth.

8. The apparatus of claim 6 wherein the local mean is computed utilizing pixel intensity.

9. A method of bit-depth reduction programmed in a memory of a device comprising:
a. selecting a search window for each target patch;
b. computing a local mean using a local window around the target patch;
c. determining a leading bit from the local mean for each target patch; and
d. transforming the search window into a low bit-depth window by choosing n bits from each pixel in the search window, wherein the n bits are the ones starting from and following the leading bit position.

10. The method of claim 9 wherein the search window comprises a list of candidate patches.

11. The method of claim 9 wherein the reduced bit-length is less than a total bit depth.

12. The method of claim 9 wherein the local mean is computed utilizing pixel intensity.

13. The method of claim 9 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, a smart phone, a portable music player, a tablet computer, a mobile device, a video player, a video disc writer/player, a television, and a home entertainment system.

14. An apparatus comprising:
a. an image acquisition component for acquiring an image;
b. a memory for storing an application, the application for:
i. selecting a search window from the image for each target patch;
ii. computing a local mean by averaging pixel values within a local window around the target patch;
iii. determining a leading bit position using the local mean; and
iv. transforming the search window into a low bit-depth window by choosing n bits from each pixel in the search window, wherein the n bits are the ones starting from and following the leading bit position; and
c. a processing component coupled to the memory, the processing component configured for processing the application.

15. The apparatus of claim 14 wherein the search window comprises a list of candidate patches.

16. The apparatus of claim 14 wherein the chosen n bits is fewer than a total bit depth.

17. The apparatus of claim 14 wherein the local mean is computed utilizing pixel intensity.
